(19) United States
(12) Patent Application Publication
(10) Pub. No.: US 2003/0143884 A1
(43) Pub. Date: Jul. 31, 2003

(54) Pin-typed electric connection device

(76) Inventors: Moriss Kung, Taipei (TW); Kwun-Yao Ho, Taipei (TW); Lin-Chou Tung, Taipei (TW); Jackie Fu, Taipei (TW)

Correspondence Address: Raymond Sun, 12420 Woodhall Way, Tustin, CA, 92782, US

(21) Appl. No.: 10/256,311

(22) Filed: Sep. 27, 2002

(30) Foreign Application Priority Data
Jan. 29, 2002 (TW) 91200861

(51) Int. Cl. H01R 4/50

(52) U.S. Cl. 439/342

(57) ABSTRACT

The invention provides a pin-typed electric connection device, which provides an electric connection with a circuit board having a circuit layout and several electronic elements. The pin-typed electric connection device includes: a base seat, a gliding seat, and an actuating mechanism. The base seat makes an electric connection with the circuit board. On the top surface of the base seat, there is one blocking-and-fixing portion. The gliding seat is placed on the top surface side of the base seat by a relatively gliding manner. There is one insetting-and-placing portion at an appropriate position of the gliding seat in corresponding to the blocking-and-fixing portion. The actuating mechanism is brought along with the blocking-and-fixing portion and the insetting-and-placing portion. The gliding seat is driven by the actuating mechanism to proceed an appropriately linear gliding displacement.

### 1. FIELD OF THE INVENTION

The invention relates to a pin-typed electric connection device, especially to a kind of pin-typed electric connection device that be arranged and fixed on a circuit board for providing an electric connection between an IC package and the circuit board, wherein the IC package be inserted and placed in the pin-insertion array disposed on the circuit substrate having a circuit layout.

### 2. BACKGROUND OF THE INVENTION

Since long time ago, there are two ways to dispose an IC package on a circuit board (or a main board) in tradition. One way is to weld it directly and fixedly, while another way is replaceable and insertable. This kind of pin-typed electric connection device is usually adapted for the IC package requiring up-graded and renewed or for the IC device of higher price. When one of the circuit board or the IC package is malfunctioned or needed for renewing, another element still is kept for continuous usage. For example, the central processing unit (i.e., the CPU) is a typical example.

Please refer to FIG. 1 and FIG. 2, which show the typical insertable IC device 10 that be seen in current market. In tradition, in order to pursue the objects of insertable manner and excellent electric connection, plural pins 111 are disposed on the IC package 11, and the socket 13 having plural pinholes 131 is arranged on the circuit board 12 for inserting and placing the IC package 11. In tradition, there are two ways for packaging an IC package 11, that is, the lead frame and the ball grid array (i.e., the BGA). In recent years, for the IC package pursuing high efficiency (i.e., high heat dissipation rate) and high leg number, the flip chip BGA package is usually applied. As shown in FIG. 1, its basic comprising elements usually includes an IC chip 112 that is disposed on a side surface of a substrate 113, several solders 114 that are arranged on the other side surface of the substrate 113 and are coupled electrically to the chip 112 by the circuit design of the substrate 113, and a heat sink 115 that is adhered to the another non-active surface of the chip 112. Since the pin 111 is not an object of high rigidity, so it is easy to twist and damage during the procedures of pulling and insertion and it is also uneasy to connect with the solders 114 in stable way. Therefore, in the current technique, after being molded and fixed on an interposer 116, the plural pins 111 are then welded to the solders 114.

In order to provide an insertion function for the pins 111 of the above-mentioned IC package 11 according to the prior arts and to pursue the inserting function, the current socket 13 according to the prior arts all includes following elements: an insertion seat 132 having plural pinholes 131 is welded on the circuit board 12, a gliding plate 133 that is arranged and covered on the top surface of the insertion seat 132 by a linearly guidable manner, and a long pulling rod 134 that is arranged at the side of the insertion seat 132 for driving the gliding plate 133 to proceed a slightly gliding movement. Conduction metals (not shown) are arranged in each of the pinholes 131 of the insertion seat 132, and solders 135 are arranged at the bottom of the pinholes 131 for being welded and electrically connected with the circuit board 12. Slightly larger openings (not shown) are also arranged on the positions of the gliding plate 133 in corresponding to the pinholes 131. By pressing down the long pulling rod 134, it is then rotated to a horizontal position with respect to the insertion seat 132 by taking the rod axis 136 as a rotation axis center, so that the gliding plate 133 is made to proceed a slightly gliding movement to hold the pins 111 of the IC package 11 tightly in the pinholes 131. When it is going to pull out the IC package 11, the long pulling rod 134 is rotated to a position that is vertical to the insertion seat, so that the pin 111 will be loosened to take out the IC package 11.

Since the occupying area of the long pulling rod 134 of the above-mentioned socket 13 is too large, an additional space is needed for accommodating the long pulling rod 134 and its rod axis 136, so that the occupying area of the circuit board is too large. The long pulling rod 134 needs a large range for rotation motion, and within the rotation range of the long pulling rod 134, there is no any other element to be arranged, so the application of space is limited and the cost payment is increased invisibly. Therefore, how to reduce the manufacture cost and promote the industrial competition has become an urgent problem that has to be solved by relative industry and manufacturers.

### SUMMARY OF THE INVENTION

The main object of the invention is to provide a pin-typed electric connection device, in which an actuating mechanism applies a rotation motion to drive a gliding seat to proceed appropriate linear displacement over a top surface of a base seat, so that the shortcomings of the complicated structure, the large occupying area, and large operation space for the long pulling rod device according to the prior arts can be overcome, while the manufacturing cost is lowered down relatively.

To achieve above-mentioned object, the pin-typed electric connection device according to the invention provide an electric connection between at least one IC package having plural pins and a circuit board having circuit layout and several electronic element, wherein the pin-typed electric connection device is comprised of a base seat, a gliding seat, and an actuating mechanism.

The base seat be electrically connected with the circuit board, and plural pinholes are arranged on a top surface of the base seat, and the positions of the plural pinholes are just corresponded to that of the plural pins, and the top surface has a blocking-and-fixing portion.

The gliding seat can be placed on the top surface side of the base seat by a relatively gliding manner, wherein plural openings are arranged on the gliding seat, and the positions of the plural openings are just corresponded to that of each pinhole respectively, and there is one insetting-and-placing portion located at an appropriate position that the gliding seat and the blocking-and-fixing portion are corresponded to each other, and the gliding seat has a guiding frame, which is arranged at the at least two corresponding side edges of the base seat for providing a limitation for the gliding seat to proceed a linearly gliding motion along the extension direction of the guiding frame.

The actuating mechanism is brought along with the blocking-and-fixing portion and the insetting-and-placing portion and has a pivotal axis that is pivotally arranged in the blocking-and-fixing portion and the insetting-and-placing portion by the way of pivotal rotation, and a poking rod that is connected to one end of the pivotal axis and, by applying a force to the poking rod, the pivotal axis is made to proceed a rotation motion for driving the gliding seat to proceed an appropriate amount of linearly gliding motion.

In the preferred embodiment of the pin-typed electric connection device according to the invention, the gliding seat has a insetting-and-fixing mechanism, which is arranged at one top surface of the gliding seat, and the actuating mechanism choose to be connected with the insetting-and-fixing mechanism to fix the IC package and choose to be separated from the insetting-and-fixing mechanism to drive the gliding seat to proceed an appropriate amount of linearly gliding motion.

For your esteemed reviewing committee members to understand and recognize the invention, detailed descriptions in cooperation with corresponding drawings are presented as follows.

### BRIEF DESCRIPTION OF THE DRAWINGS

FIG. 1 is a side perspective view for the pin-typed electric connection device according to the prior arts.

FIG. 2 is a top view of FIG. 1 that shows a pin-typed electric connection device according to the prior arts.

FIG. 3A is a three-dimensional structural explosive illustration for the first preferred embodiment of the pin-typed electric connection device according to the present invention.

FIG. 3B is a three-dimensional structural assembling illustration for the first preferred embodiment of the pin-typed electric connection device according to the present invention.

FIG. 3C is a sectional structural illustration for the first preferred embodiment of the pin-typed electric connection device according to the present invention.

FIG. 3D is a top view structural illustration for the first preferred embodiment of the pin-typed electric connection device according to the present invention.

FIG. 3E is an illustration for another preferred embodiment of the insetting-and-fixing mechanism of the pin-typed electric connection device according to the present invention.

FIG. 4A is a three-dimensional structural explosive illustration for the second preferred embodiment of the pin-typed electric connection device according to the present invention.

FIG. 4B is a three-dimensional structural assembling illustration for the second preferred embodiment of the pin-typed electric connection device according to the present invention.

FIG. 5A is a three-dimensional structural explosive illustration for the first preferred embodiment of the cooperation between the blocking-and-fixing portion and the actuating mechanism according to the present invention.

FIG. 5B is a three-dimensional structural explosive illustration for the second preferred embodiment of the cooperation between the blocking-and-fixing portion and the actuating mechanism according to the present invention.

FIG. 6 is the illustration for the positions of the center of gravity of the pin-typed electric connection device according to the present invention.

### DETAILED DESCRIPTION OF THE PREFERRED EMBODIMENTS

The main technique spirit of the invention is to apply a rotation motion of an actuating mechanism to drive a gliding seat to proceed an appropriate amount of linear displacement over the top surface of the base seat, so that the shortcomings of the large occupying area and the large operational space of the long pulling rod device according to the prior arts can be overcome.

The detailed means, motion manners, achieved functions, and the other technique characteristics of the pin-typed electric connection device according to the invention are present in several preferred embodiments as follows.

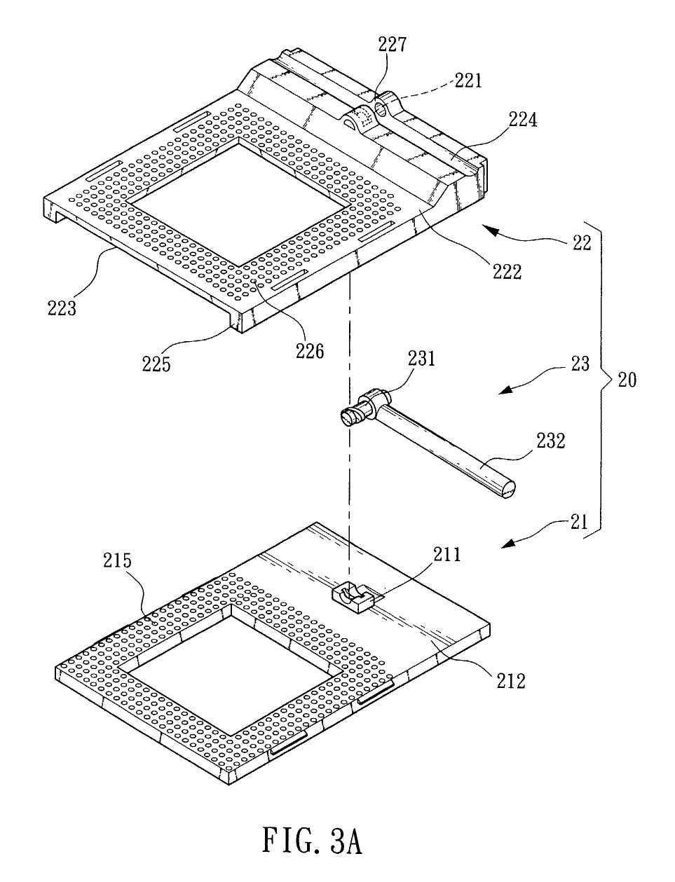

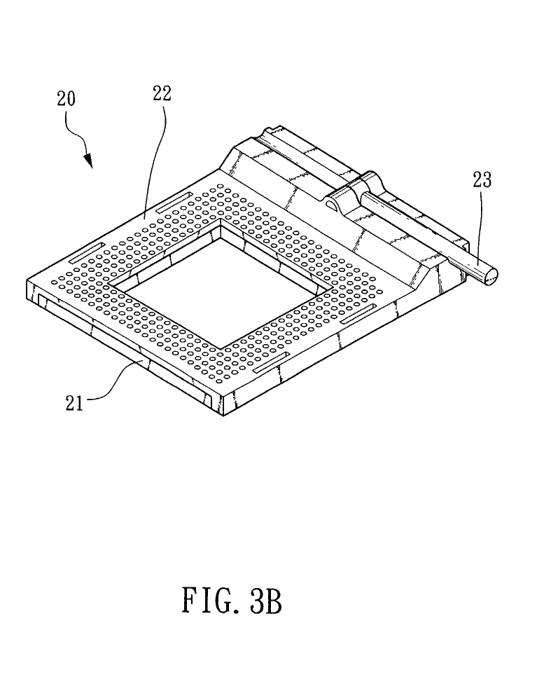

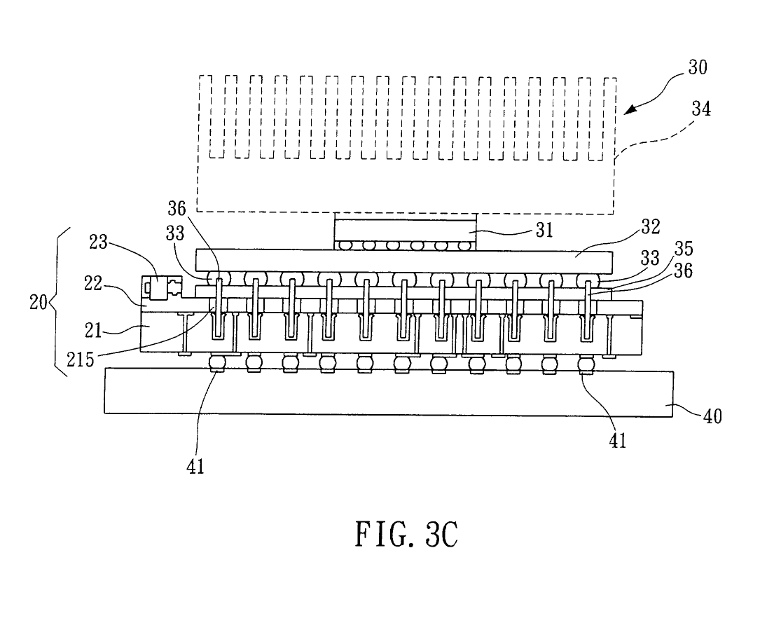

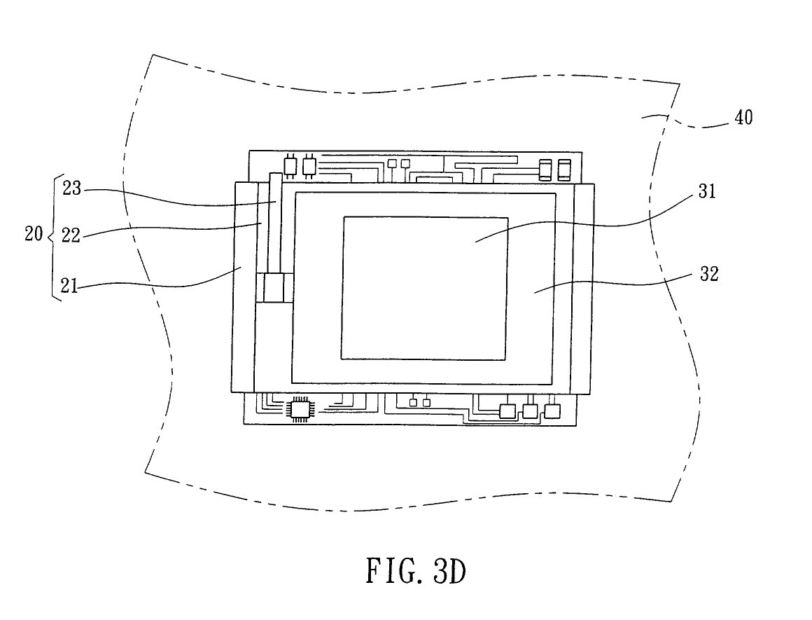

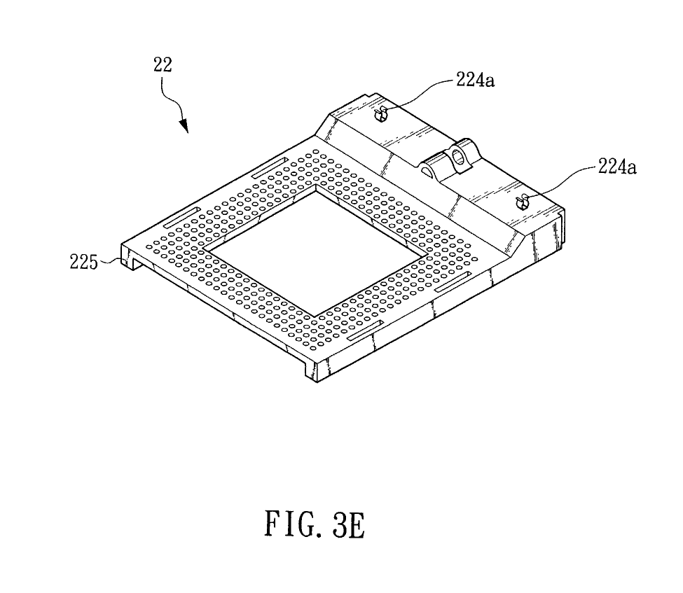

Please refer to FIG. 3A through FIG. 3D, which are the illustrations for the first preferred embodiment of the pin-typed electric connection device according to the invention. The pin-typed electric connection device is mainly applied as an electric connection for an IC package 30 and a circuit board, and both of which are separately.

The IC package 30 is comprised of an IC chip 31 and a substrate 32 disposed with circuit layout. Several solder balls 33 are arranged on the bottom side surface of the substrate 32 and are connected electrically with the active side of the IC chip 31 through the circuit layout. Another side of the IC chip 31 is adhered with a heat sink 34 for enhancing the efficiency of heat dissipation. In this preferred embodiment, the IC package 30 is a well-known flip chip BGA element or other kinds of BGA element, such as: wire bonding or tape automated bonding or flip-chip bonding elements, etc. In this preferred embodiment, the IC package 30 is same as the prior arts, that is, an interposer 35 and plural pins 36 are arranged at the bottom side surface of the substrate 32, and the pins 36 are connected electrically with the corresponding conduction balls 33.

Several contact pads 41 made of conductive materials are formed on the upper surface of the circuit board 40 and, preferably, the materials of the contact pad 41 be nickel, gold, chromium, copper, iron, aluminum, titanium, lead, tin, or the alloy thereof. The several contact pads exposed outside are provided for the pin-typed IC connection device 20 of the invention to proceed welding and connection. Of course, other well-known electric components, such as: capacitor, resistor, and other IC package (not shown), etc. can also be arranged on the circuit board 40. Since the part for arranging electronic components on the circuit board 40 is belonged to the prior arts and is not the technique characteristic of the invention, so detailed description is not repeated herein.

In the preferred embodiments of the invention, the pin-typed electric connection device includes: a base seat 21, a gliding seat 22, and an actuating mechanism 23. Plural pinholes 215 and a blocking-and-fixing portion 211 protruded out the top surface 212 of the base seat 21 are arranged on the top surface 212 of the base seat 21. Since the positions of the plural pinholes 211 are just corresponded respectively to those of the plural pins 36, so the pins 36 of the IC package 30 be inserted one by one into the pinholes to connect and position the IC package 30 on the top surface 212 of the base seat 21. Wherein, it also design that the pinholes 215 is penetrated through the base seat 21 and, at this time, the base seat 21 then be designed as a base seat for a single layer board having single layer of circuit layout, double layers board having double layers of circuit layout, or multiple layers board having multiple layers of circuit layout, etc., or other formation of the plastic materials without any circuit layout for reducing the manufacturing cost. Such kinds of variations can be executed by any one who is skilled in such arts according to the above disclosure, but those variations still possess the merits of the invention and are also within the spirit and range of the invention, so detailed description is not presented herein any more.

In the preferred embodiment of the invention, the gliding seat 22 be placed on the top surface side of the base seat 21 in a relatively gliding manner and, on the gliding seat, there are still arranged with: plural openings 226, a insetting-and-placing portion 221, a insetting-and-fixing mechanism 224, a guiding frame 225, and a opening 227. The positions of the plural openings 226 are just corresponded to those of the pinholes 215 respectively, and the size of the opening 226 is slightly larger than that of the pinholes 215. The insetting-and-placing portion 221 is arranged on a bottom surface 223 of the gliding seat 22. The insetting-and-placing portion 221 is corresponded to blocking-and-fixing portion 211. The insetting-and-fixing mechanism 224 is arranged on a top surface 222 of the gliding seat 22 that is corresponded to the bottom surface 223. The guiding frame 225 is arranged at the at least two corresponding side edges of the base seat 21 and is extended along the direction of the side edges of the base seat 21. The guiding frame 225 is provided for holding the gliding seat 22 on the top surface of the base seat 21 for preventing from loosening and dropping off and, in the mean time, the guiding frame 225 also restrict the gliding seat 22 to proceed a linearly gliding motion only along the extension direction of the guiding frame 225. Wherein, the gliding seat 22 and the guiding frame 225 are two separating independent devices. Of course, the gliding seat 22 and the guiding frame 225 also be a single device formed integrally. Such kinds of structural variations can be executed by any one who is skilled in this arts according to the above disclosure and, however, those variations still possess the merits of the invention and also are within the spirit and range of the invention, so repetitious description is not presented herein any more. The opening 227 is penetrated through the top surface 222 of the gliding seat 22 and the bottom surface 223 of the gliding sear so that, when the actuating mechanism 23 be provided by the openings 227 to be extended from the bottom surface 223 of the gliding seat 22 through the openings 227 and out of the top surface 222 of the gliding seat 22, the actuating mechanism 23 be made to choose a connection with the insetting-and-fixing mechanism 224.

The actuating mechanism is brought along with the blocking-and-fixing portion 221 and the insetting-and-placing portion 221 and drives the gliding seat 22 to proceed an appropriate amount of the linearly gliding motion. In this preferred embodiment, the actuating mechanism 23 includes: a pivotal axis 231 and a poking rod 232. In the preferable embodiments of the invention, the cross-section of the poking rod 232 is formed as a round shape and, of course, it may also be designed as a rectangular shape or other forms. Such kind of variation implemented by those who are skilled in such arts according to above disclosure, but it still possesses the merits of the invention and it is also within the spirit and scope of the invention, so a detailed description is not presented herein any further. The pivotal axis 231 is pivotally arranged in the blocking-and-fixing portion 211 and the insetting-and-placing portion 221 by a pivotally rotatable manner, while the poking rod 232 is connected to one end of the pivotal axis 231. The combination way of the poking rod 232 is that the poking rod 232 is extended from the bottom surface 223 of the gliding seat 22 through the opening 227 and out of the top surface 222 of the gliding seat 22 to form a state that a force be applied on the poking rod 232. When a force is applied on the poking rod 232, the pivotal axis 231 is made to proceed a rotation motion and, since the base seat 21 is fixed, so the gliding seat 22 is capable of proceeding a linearly gliding motion and, by the rotation motion, the gliding seat 22 be driven to proceed an appropriate amount of the linearly gliding motion.

In the preferred embodiment of the invention, the insetting-and-fixing mechanism 224 is designed as a form of one side or two sides open groove. Please refer to FIG. 3E, which is an illustration of another preferred embodiment of the insetting-and-fixing mechanism of the pin-typed electric connection device according to the invention. In this embodiment, the insetting-and-fixing mechanism 224 is designed as at least one holding seat 224a and, as shown in the drawing, there is one in each left and right side in symmetry. Of course, it can also be two seats arranged at the same side, or be designed as more than three. Such kind of mechanism make the insetting-and-fixing mechanism 224 is able to provide the actuating mechanism 23 to be connected, fixed, and placed. These variations can be executed and varied by those who are skilled in such arts according to above-mentioned disclosure, but these variations still have the merits of the invention and are also within spirit and range of the invention, so repetitious description is not presented herein anymore.

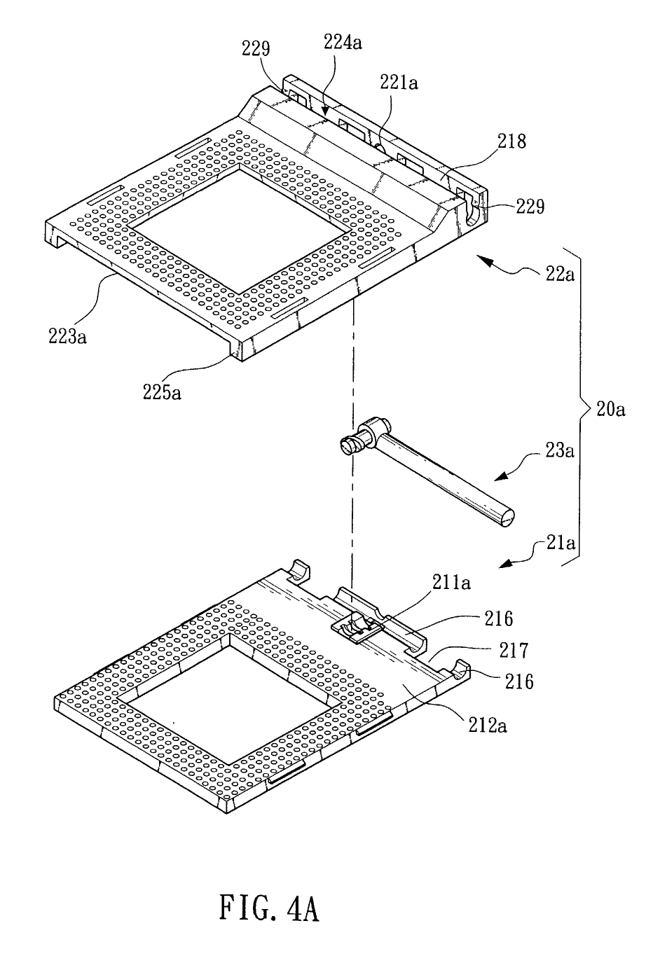

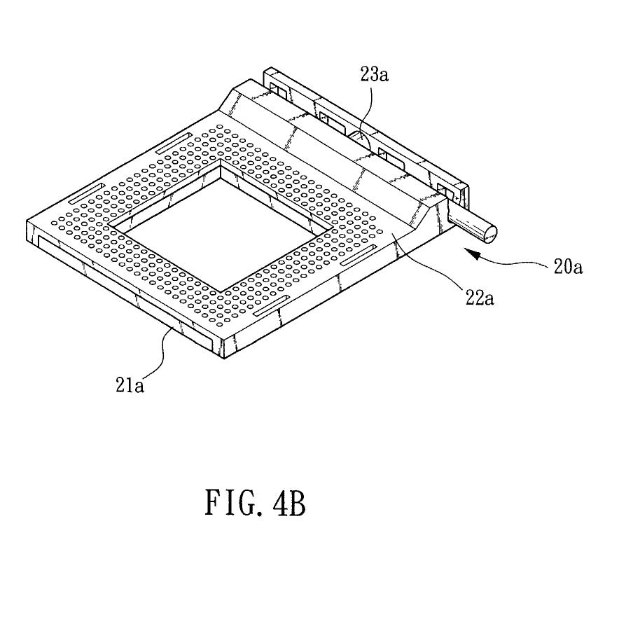

Please refer to FIG. 4A and FIG. 4B, which are the illustrations of the second preferred embodiment of the pin-typed electric connection device according to the invention. In the second preferred embodiment according to the invention as described in the follows, since most elements are same or similar to those of the aforementioned embodiment, so the same element will be designated with same name or reference number directly and, for the similar element, a same name will be given but an English letter is added to the original reference number for distinguishing and its function is not described repetitiously. In order to reduce the height of the pin-typed electric connection device of the invention for the convenience for connecting with the IC package 30, the pin-typed electric connection device 20a according to this embodiment is comprised of a base seat 21a, a gliding seat 22a, and an actuating mechanism 23a. The base seat 21a has a blocking-and-fixing portion 211a that is openly arranged at the top surface 212a of the base seat 21a, and an insetting-and-placing portion 221a is arranged on the bottom surface 223a of the gliding seat 22a by a protruding way, and the insetting-and-placing portion 221 is corresponded to the blocking-and-fixing portion. In order to make the actuating mechanism 23a be brought along between the blocking-and-fixing portion 211a and the insetting-and-placing portion 221a, the base seat 21a is extended out several claws 216 that provide the actuating mechanism 23a to be placed after it being connected. A one side open or both sides open guiding groove 217 is arranged between each claw 216. The gliding seat 22a can be placed on the top surface side of the base seat 21a with a relatively gliding manner and, when gliding relatively, the gliding seat 22a proceeds a linearly gliding motion along the extensive direction of the guiding frame 225a and, at this time, the gliding seat 22a has a guiding block 228 thereon that just be moved on the guiding groove 217 to provide the motion to be executed smoothly without any hindrance. In the preferred embodiment of the invention, the insetting-and-fixing mechanism 224a is designed as a form of open groove, and at least one block 229 is arranged at the side end of the insetting-and-fixing mechanism 224a. The block 229 be provided for fixing the actuating mechanism 23a and, as shown in the drawing, the number of the block 229 is two, and there are blocks 229 all arranged at the two side ends. Of course, the number of the block 229 also is only one, or there is just one block 229 arranged at one side end. In the preferred embodiment of the invention, the actuating mechanism 23a is selected to be fixed at the right side of the insetting-and-fixing mechanism 224a, of course, it may also be selected to be fixed at the left side of the insetting-and-fixing mechanism 224a when used. Such kinds of variations and combination of convex, concave, and number can be executed by those who are skilled in this sort of arts in according to aforementioned disclosure, and these variations still have the merits of the invention and are also within the spirit and arrange of the invention, so repetitious description will not be presented herein anymore.

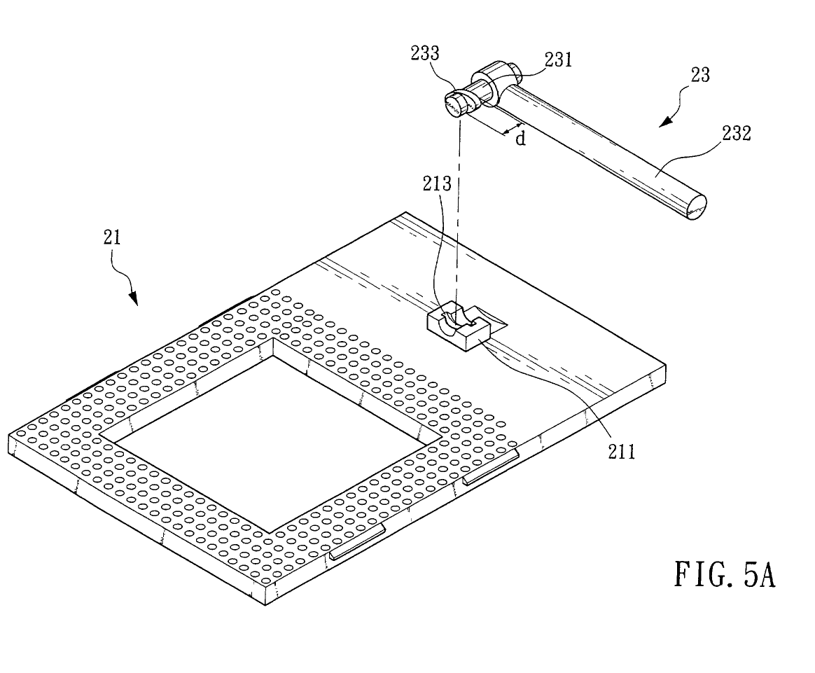

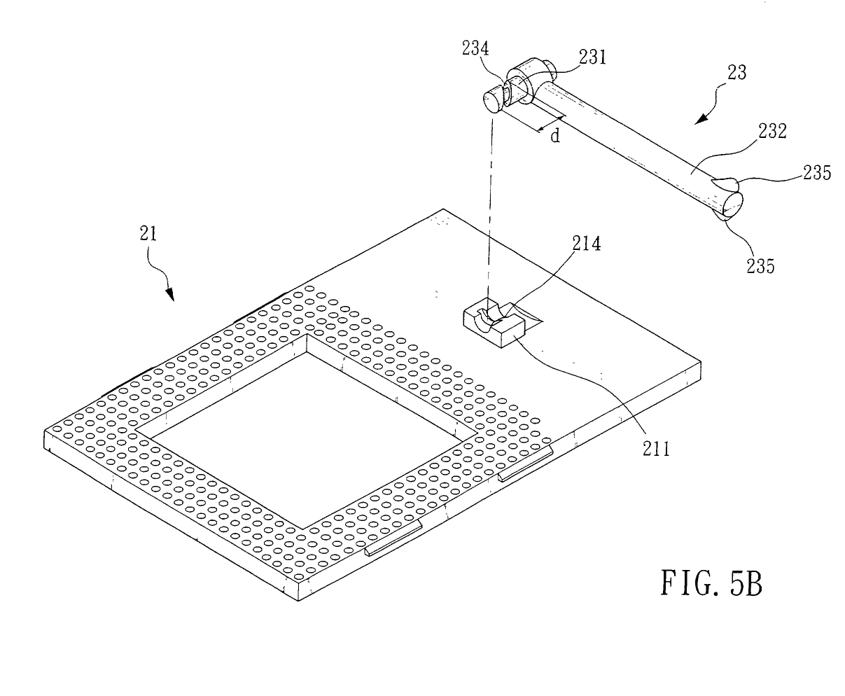

To understand the aforementioned first and second preferred embodiments, please refer to FIG. 5A and FIG. 5B, which are the three-dimensional structural explosive illustrations for the preferred embodiment for the cooperation between the blocking-and-fixing portion and the actuating mechanism according to the invention. In this preferred embodiment of the invention, the actuating mechanism 23 has a poking block 233. Of course, the blocking-and-fixing portion 211 also has a concave hole 213 that is corresponded to the poking block 233. The concave hole 213 is provided for accommodating and fixing the poking block 233 and guides the moving direction of the poking block 233. The poking block 233 is connected to the pivotal axis 231 with an appropriate angle. Thereby, when the poking rod 232 brings along the pivotal axis 231 to rotate one round, the poking block 233 proceed a rotation motion by taking the pivotal axis as a rotation axial center to push the insetting-and-placing portion forward and make the gliding seat 22 proceed the linearly gliding movement of a displacement d that is proportional to the rotation angle of the pivotal axis 231. In the preferred embodiment of the invention, the poking angle of the poking rod is 180 degree, so it will make the gliding seat 22 to proceed a linearly gliding motion of ½ displacement (½ d). Of course, it also is based on the intended displacement of the linearly gliding motion of the gliding seat 22 and the potable angle of the poking rod 232 to design the poking angle to 90 degree or other angles. Therefore, the cooperation between the blocking-and-fixing portion and the actuating mechanism of the first and the second preferred embodiments of the invention also be designed as a groove ditch 234 that is arranged along the pivotal axis 231 with appropriate angle as shown in FIG. 5B. The blocking-and-fixing portion 211 also has a convex edge 214 that is corresponded to the groove ditch 234. The convex edge 214 is provided for fixing the groove ditch 234 and guiding the moving direction of the groove ditch 234. Thereby, an effect of same displacement also is obtainable. In the preferred embodiment of the invention, the poking rod 232 has one or two protrusion ends 235acting as slip stoppers for providing better gripping during manual operation. Such kinds of structural variation will be executed and varied by those who are skilled in these sorts of arts in according to above-mentioned disclosure, and these variations still have the merits of the invention and are also within the spirit and range of the invention, so repetitious description is not presented herein anymore.

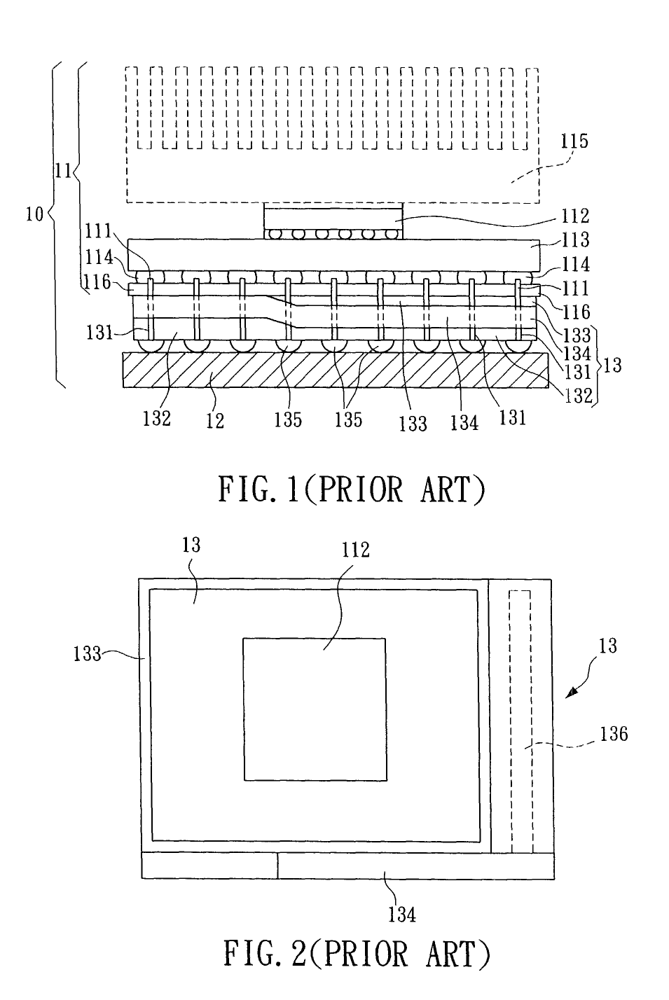

Since the occupying area of the circuit board 40 for matching with the actuating mechanism 23 of the invention is relatively less and, when the poking rod 232 is rotated during operation, only half of the space is occupied and limited by comparing with the long pulling rod device of the prior arts as shown in FIG. 1 and FIG. 2, so it is obvious that the invention really has an outstanding progress of saving and utilization in the occupying area and space.

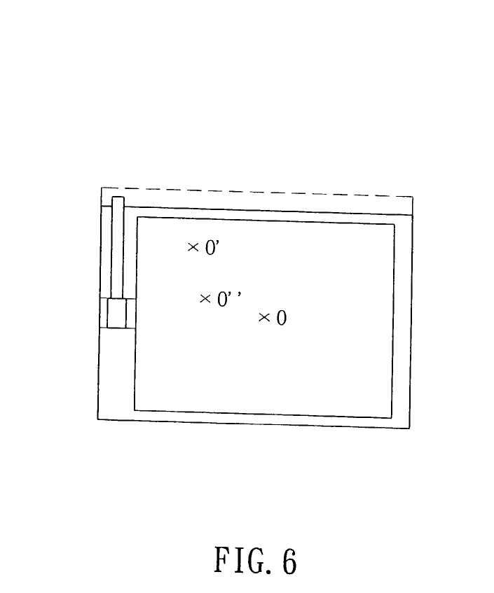

Please refer to FIG. 6, which is an illustration for the positions of the center of gravity of the pin-typed electric connection device of the invention. Since the long pulling rod of the prior arts is arranged on a side surface of the pin-typed electric connection device and a space for arranging the portion of the rod axis is extended from the pin-typed electric connection device, so the center of gravity of the pin-typed electric connection device of the prior arts is moved in great amount from the center portion (the position o as designated in the drawing) toward the direction of the arrangement of the long pulling rod and moves slightly toward the direction of the arrangement extensive for the portion of the rod axis (the position o′ as designated in the drawing). Therefore, when the pin-typed electric connection device is arranged, since large amount of gravity is biased and inclined to one side, so the parts of the pins and the pinholes are damaged. However, since the poking rod of the invention is only half of the long pulling rod of the prior arts and is located in the space extensive for arranging the rod axis portion of the long pulling rod of the prior arts, so the position of the center of gravity of the pin-typed electric connection device of the invention is closer to the central portion and is not biased to one side (the position o″ as designated in the drawing). Such kind of arrangements really can overcome the shortcomings of the prior arts, satisfy the requirements of the industry, and greatly promote the competition ability of relative business.

In summary, compared with the prior arts, the pin-typed electric connection device of the invention at least has following advantages:

1. The occupation of the circuit area and operation space is less, because the invention adopts the actuation mechanism of rotational actuation for bringing along the gliding seat for displacement and, therefore, not only is the occupying area reduced, but also is the limitation of the space is reduced during operation.

2. The manufacturing cost and the damage ratio of connection are relatively lowered. Compared with the prior arts, the structures of the elements of the gliding seat, the guiding frame, and the actuating mechanism, etc. are simpler relatively, so the production cost is lower relatively, and the biasing amount of the center of gravity is reduced and, thereby, the reduction of damage relatively satisfies the requirements of the industry and its competition ability is also promoted.

While the present invention has been shown and described with reference to a preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the sprit of the present invention.

What is claimed is:

1. A pin-typed electric connection device, which provide an electric connection with a circuit board having circuit layout and several electronic components, comprising:
a base seat, which be connected electrically with the circuit board, and one top surface of the base has a blocking-and-fixing portion;
a gliding seat, which be placed on the top surface side of the base seat with a relatively gliding way, and an insetting-and-placing portion is arranged at an appropriate position of the gliding seat in corresponding to the blocking-and-fixing portion; and
an actuating mechanism, which is brought along with both the blocking-and-fixing portion and the insetting-and-placing portion, and the actuating mechanism drives the gliding seat to proceed an appropriate amount of a linearly gliding motion.

2. The pin-typed electric connection device according to claim 1, wherein the gliding seat has a guiding frame, which is arranged at the at least two corresponding side edges of the base seat for providing a limitation for the gliding seat that proceeds the linearly gliding motion along the extensive direction of the guiding frame.

3. The pin-typed electric connection device according to claim 2, wherein the gliding seat and the guiding frame are formed integrally to become a single device.

4. The pin-typed electric connection device according to claim 2, wherein the gliding seat and the guiding frame are two independent devices.

5. The pin-typed electric connection device according to claim 1, wherein the actuating mechanism has:
a pivotal axis, which is pivotally arranged in the blocking-and-fixing portion and the insetting-and-placing portion by a pivotally rotatable manner; and
a poking rod, which is connected to one end of the pivotal axis and, by applying a force on the poking rod, the pivotal axis is made to proceed a rotation motion.

6. The pin-typed electric connection device according to claim 5, wherein the gliding seat is arranged with an insetting-and-fixing mechanism, which be provided for placing and fixing the poking rod.

7. The pin-typed electric connection device according to claim 6, wherein the insetting-and-fixing mechanism is at least one holding seat.

8. The pin-typed electric connection device according to claim 6, wherein the insetting-and-fixing mechanism is an open groove.

9. The pin-typed electric connection device according to claim 5, wherein the actuating mechanism has a poking block, which is connected to the pivotal axis with an appropriate angle, and it be based on the pivotal axis as an axial center for proceeding a rotation to push the insetting-and-placing portion to make the gliding seat proceed the linearly gliding motion.

10. The pin-typed electric connection device according to claim 9, wherein the blocking-and-fixing portion has a concave hole that is corresponded to the poking block.

11. The pin-typed electric connection device according to claim 5, wherein a groove ditch is arranged along the pivotal axis with an appropriate angle and, based on the pivotal axis as an axis, the groove ditch proceeds a rotation to push the insetting-and-placing portion to make the gliding seat proceed the linearly gliding motion.

12. The pin-typed electric connection device according to claim 11, wherein the blocking-and-fixing portion has a convex edge that is corresponded to the groove ditch.

13. A pin-typed electric connection device, which provide an electric connection between at least one IC package having plural pins and a circuit board having circuit layout and several electronic elements, comprising: a base seat, which be connected electrically with the circuit board, and one top surface of the base has a blocking-and-fixing portion;
a gliding seat, which be placed on the top surface side of the base seat with a relatively gliding way, and a bottom surface of the gliding seat has an insetting-and-placing portion that is corresponded to the blocking-and-fixing portion, and a top surface corresponding to the bottom surface has an insetting-and-fixing mechanism; and
an actuating mechanism, which is brought along with both the blocking-and-fixing portion and the insetting-and-placing portion, and the actuating mechanism chooses to be connected with the insetting-and-fixing mechanism for fixing the IC package, and the actuating mechanism chooses to be separated from the insetting-and-fixing mechanism to drive the gliding seat to proceed an appropriate amount of a linearly gliding motion.

14. The pin-typed electric connection device according to claim 13, wherein a top surface of the base seat is arranged with plural pinholes, of which the positions are just corresponded to those of the plural pins respectively.

15. The pin-typed electric connection device according to claim 14, wherein plural openings are arranged on the gliding seat, and the positions of the plural openings are just corresponded to those of the plural pinholes respectively.

16. The pin-typed electric connection device according to claim 13, wherein the gliding seat has a guiding frame, which is arranged at the at least two corresponding side edges of the base seat for providing a limitation for the gliding seat that proceeds the linearly gliding motion along the extensive direction of the guiding frame.

17. The pin-typed electric connection device according to claim 16, wherein the gliding seat and the guiding frame are formed integrally to become a single device.

18. The pin-typed electric connection device according to claim 16, wherein the gliding seat and the guiding frame are two independent devices.

19. The pin-typed electric connection device according to claim 13, wherein the insetting-and-fixing mechanism is at least one holding seat.

20. The pin-typed electric connection device according to claim 13, wherein the insetting-and-fixing mechanism is an open groove.

21. The pin-typed electric connection device according to claim 13, wherein the actuating mechanism has:
a pivotal axis, which is pivotally arranged in the blocking-and-fixing portion and the insetting-and-placing portion by a pivotally rotatable manner; and
a poking rod, which is connected to one end of the pivotal axis and, by applying a force on the poking rod, the pivotal axis is made to proceed a rotation motion.

22. The pin-typed electric connection device according to claim 13, wherein the actuating mechanism has a poking block, which is connected to the pivotal axis with an appropriate angle, and it be based on the pivotal axis as an axial center for proceeding a rotation to push the insetting-and-placing portion to make the gliding seat proceed the linearly gliding motion.

23. The pin-typed electric connection device according to claim 22, wherein the blocking-and-fixing portion has a concave hole that is corresponded to the poking block.

24. The pin-typed electric connection device according to claim 13, wherein a groove ditch is arranged along the pivotal axis with an appropriate angle and, based on the pivotal axis as an axial center, the groove ditch proceeds a rotation to push the insetting-and-placing portion to make the gliding seat proceed the linearly gliding motion.

25. The pin-typed electric connection device according to claim 24, wherein the blocking-and-fixing portion has a convex edge that is corresponded to the groove ditch.

26. A pin-typed electric connection device, which provide an electric connection with a circuit board having circuit layout and several electronic components, comprising:
a base seat, which be connected electrically with the circuit board, and one top surface of the base has a blocking-and-fixing portion;
a gliding seat, which be placed on the top surface side of the base seat with a relatively gliding way, and an insetting-and-placing portion is arranged at an appropriate position of the gliding seat in corresponding to the blocking-and-fixing portion; and
an actuating mechanism, which is brought along with the blocking-and-fixing portion and the insetting-and-placing portion and has a pivotal axis that is pivotally arranged in the blocking-and-fixing portion and the insetting-and-placing portion by the way of pivotal rotation, and a poking rod that is connected to one end of the pivotal axis and, by applying a force to the poking rod, the pivotal axis is made to proceed a rotation motion for driving the gliding seat to proceed an appropriate amount of linearly gliding motion.

27. The pin-typed electric connection device according to claim 26, wherein the gliding seat has a guiding frame, which is arranged at the at least two corresponding side edges of the base seat for providing a limitation for the gliding seat that proceeds the linearly gliding motion along the extensive direction of the guiding frame.

28. The pin-typed electric connection device according to claim 27, wherein the gliding seat and the guiding frame are formed integrally to become a single device.

29. The pin-typed electric connection device according to claim 27, wherein the gliding seat and the guiding frame are two independent devices.

30. The pin-typed electric connection device according to claim 26, wherein the gliding seat is arranged with an insetting-and-fixing mechanism, which be provided for placing and fixing the poking rod.

31. The pin-typed electric connection device according to claim 30, wherein the insetting-and-fixing mechanism is at least one holding seat.

32. The pin-typed electric connection device according to claim 30, wherein the insetting-and-fixing mechanism is an open groove.

33. The pin-typed electric connection device according to claim 26, wherein the actuating mechanism has a poking block, which is connected to the pivotal axis with an appropriate angle, and it be based on the pivotal axis as an axial center for proceeding a rotation to push the insetting-and-placing portion to make the gliding seat proceed the linearly gliding motion.

34. The pin-typed electric connection device according to claim 33, wherein the blocking-and-fixing portion has a concave hole that is corresponded to the poking block.

35. The pin-typed electric connection device according to claim 26, wherein a groove ditch is arranged along the pivotal axis with an appropriate angle and, based on the pivotal axis as an axis, the groove ditch proceeds a rotation to push the insetting-and-placing portion to make the gliding seat proceed the linearly gliding motion.

36. The pin-typed electric connection device according to claim 35, wherein the blocking-and-fixing portion has a convex edge that is corresponded to the groove ditch.
